(19) United States
(12) Patent Application Publication
(10) Pub. No.: US 2014/0208623 A1
(43) Pub. Date: Jul. 31, 2014

(54) DETACHABLE MEMBER FOR A HANGER

(71) Applicant: Chi-Tsai CHANG, Taichung City (TW)

(72) Inventor: Chi-Tsai CHANG, Taichung City (TW)

(21) Appl. No.: 13/799,905

(22) Filed: Mar. 13, 2013

(30) Foreign Application Priority Data
Jan. 25, 2013 (TW) 102201737

(51) Int. Cl. G09F 3/16

(52) U.S. Cl. CPC G09F 3/16
USPC 40/299.01

(57) ABSTRACT

A detachable member for detachably mounting to a hanger is provided. The hanger includes a first surface and a second surface. The detachable member includes a first clamping portion, a second clamping portion and a connecting mechanism. The first and second clamping portions are connected together via the connecting mechanism and disposed respectively on the first and second surfaces. Whereby, the detachable member is pretty conspicuous, recognizable and attractive, and misplacement of an article with the detachable member on a suspender can be avoided and the management of articles is efficient.

### BACKGROUND OF THE INVENTION

1. Field of the Invention

The present invention relates to a detachable member for a hanger.

2. Description of the Prior Art

A hanger is used for exhibition of an article attached thereon. The hanger is formed with hanging hole and hung on a suspender through that the suspender is disposed through the hanging hole. To make the article conspicuous, recognizable and attractive, a conventional hanger such as one disclosed in TW590062 is provided with an integrally-formed tag portion. However, since the tag portion is located underneath the hanging hole, purchaser's view of the tag portion will be obstructed so that the hanger is not conspicuous, recognizable and attractive.

In addition, purchasers often misplace an article with a hanger on an incorrect suspender or among other articles. Since the tag portion is generally integrally formed at a lower portion of the hanger, the misplaced article is hard to observed, and thus resulting the inefficient management of articles and business conflict.

Besides, since the lower portion to which the tag portion is located is integrally formed with a conventional hanger, a new hanger is required as the tag portion is not required any more or the type of the tag portion needs to be changed. As a result, there will be problems with high production cost and inventory quantity of the old-typed hangers.

The present invention is, therefore, arisen to obviate or at least mitigate the above mentioned disadvantages.

### SUMMARY OF THE INVENTION

An object of the present invention is to provide a detachable member for a hanger, in which the detachable member is pretty conspicuous, recognizable and attractive. Furthermore, the misplacement of an article with the detachable member on a suspender can be avoided and the management of articles is efficient.

To achieve the above and other objects, a detachable member for detachably mounting to a hanger is provided. The hanger includes a first surface and a second surface. The detachable member includes a first clamping portion, a second clamping portion and a connecting mechanism. The first and second clamping portions are connected together via the connecting mechanism and disposed respectively on the first and second surfaces.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a detachable member mounted to a hanger according to a preferred embodiment of the present invention;

FIG. 2 is a breakdown drawing of a preferred embodiment of the present invention;

FIG. 3 is a partial view of FIG. 1;

FIG. 3A is a cross-sectional view taken along a cross line A-A in FIG. 3;

FIG. 3B is a cross-sectional view taken along a cross line B-B in FIG. 3;

FIG. 4 is a cross-sectional view of an alternative embodiment of the present invention; and

FIG. 5 is a cross-sectional view of another embodiment of the present invention.

### DETAILED DESCRIPTION OF THE PREFERRED EMBODIMENTS

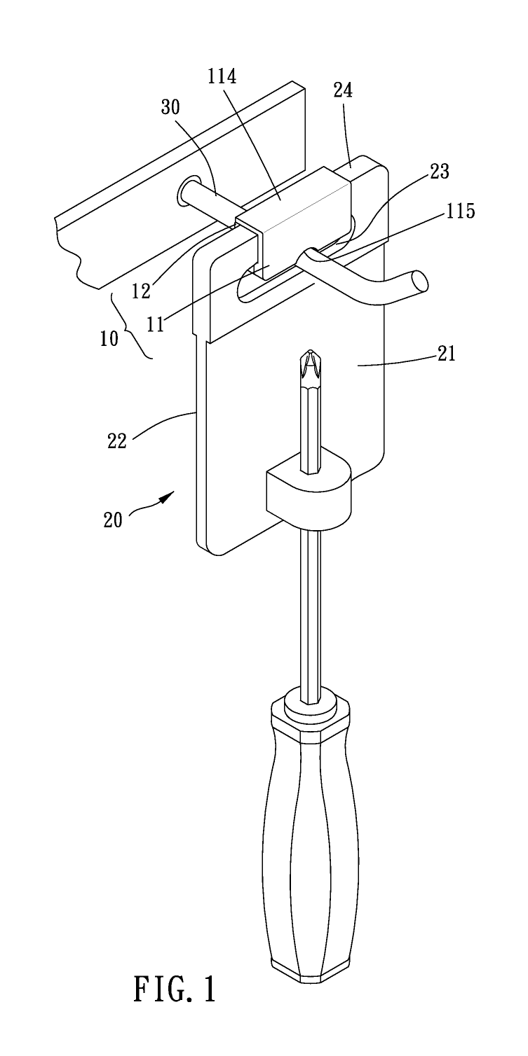

FIG. 1 shows a detachable member for a hanger according to a preferred embodiment of the present invention. The hanger 20 includes a first surface 21 and a second surface 22, and the first surface 21 of the hanger 20 is formed with a fixation portion for attachment of an article thereto. In FIG. 1, the article is, for example, a screwdriver. The hanger 20 is formed with a hanging hole 23 for insertion of a suspender 30 therewithin. The detachable member 10 may be made of rubber, plastic material or metal. As shown in FIGS. 1 to 3, the detachable member 10 includes a first clamping portion 11, a second clamping portion 12 and a connecting mechanism.

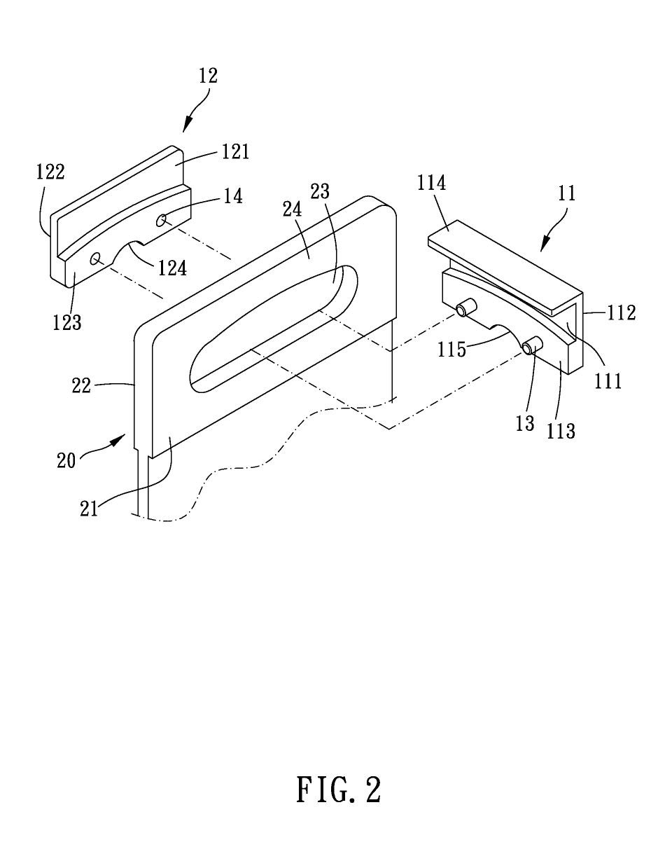

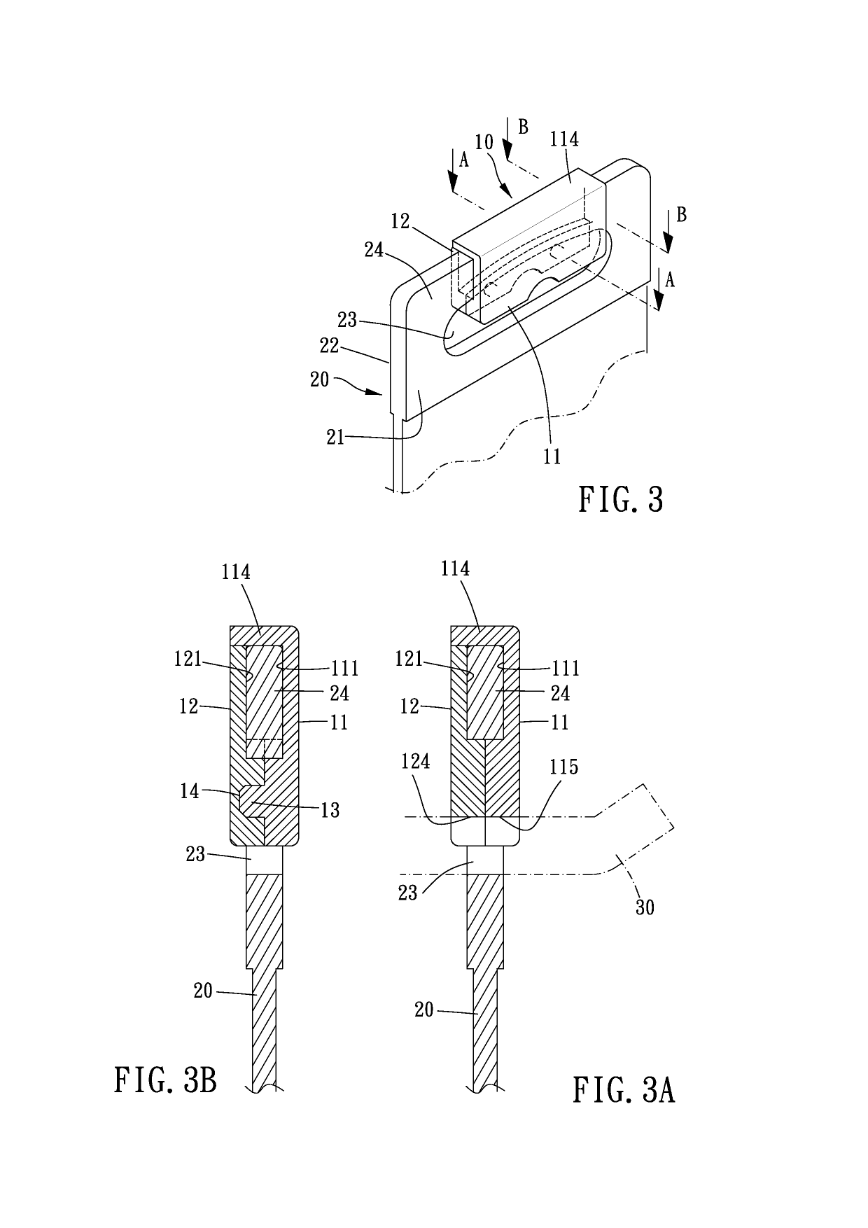

The first and second clamping portions 11, 12 are connected together via the connecting mechanism and disposed respectively on the first and second surfaces 21, 22 of the hanger 20. In this embodiment, the first clamping portion 11 includes a first surface 111 and a second surface 112, and the first surface 111 of the first clamping portion 11 is formed with a first protrusion 113. The second clamping portion 12 includes a first surface 121 and a second surface 122, and the first surface 121 of the second clamping portion 12 is formed with a second protrusion 123. The connecting mechanism includes two posts 13 and two receiving holes 14. The two posts 13 are protrusive from the first protrusion 113, and the two receiving holes 14 are formed at the second protrusion 123, as shown in FIG. 2. The posts 13 are disposed through the hanging hole 23 and inserted into the receiving holes 14, so that the first and second clamping portions 11, 12 are connected together, as shown in FIG. 1 and FIG. 3. In this embodiment, the first and second clamping portions 11, 12 are detachable, a top of the first clamping portion 11 extends to form an abutting portion 114, and the abutting portion 114 is located over and abuts against one side of the hanger 20. More specifically, the abutting portion 114 abuts against the top of the hanger 20, so that the detachable member 10 is attached stably to the hanger 20 and not easy to disengage from the hanger 20 as the first and second clamping portions 11, 12 are connected together via the connection of the corresponding posts 13 and receiving holes 14.

As shown in FIGS. 3, 3A and 3B, as the first and second clamping portions 11, 12 are connected together via the connection of the corresponding posts 13 and receiving holes 14, the first and second protrusions 113, 123 are located within the hanging hole 23, and the first surface 111 of the first clamping portion 11 and the first surface 121 the second clamping portion 12 engage respectively with the first and second surfaces 21, 22 of the hanger 20. That is, the first and second clamping portions 11, 12 are firmly clamped between the hanging hole 23 of the hanger 20 and the top of the hanger 20; specifically, as a top portion of the assembled first and second protrusions 113, 123 and a top portion of the hanging hole 23 are substantially complementary in shape, the first and second clamping portions 11, 12 can be favorably firmly clamped. In this embodiment, the top portions of the first and second protrusions 113, 123 are arcuate and convex, and the top portion of the hanging hole 23 is arcuate and concave, as shown in FIG. 2. In other words, the detachable member 10 can serve as an encompassing rib 24 between the top of the hanger 20 and the top of the hanging hole 23.

Referring further to FIGS. 1 to 3, a bottom of the first clamping portion 11 is formed with a first recess 115, a bottom of the second clamping portion 12 is formed with a second recess 124, and the first and second recesses 115, 124 correspond to each other in shape and position. As the first and second clamping portions 11, 12 are connected together via insertion of the posts 13 into the receiving holes 14, the first and second recesses 115, 124 correspond to and commute with the hanging hole 23. Preferably, the first and second recesses 115, 124 and the suspender 30 are substantially complementary in shape. Generally, the suspender 30 is cylindrical, and, in this embodiment, the first and second recesses 115, 124 are preferably circular arcs. The suspender 30 is disposed through the hanging hole 23 and positioned in the first and second recesses 115, 124, so that the first and second recesses 115, 124 can be used for positioning of the suspender 30 and hold the suspender 30.

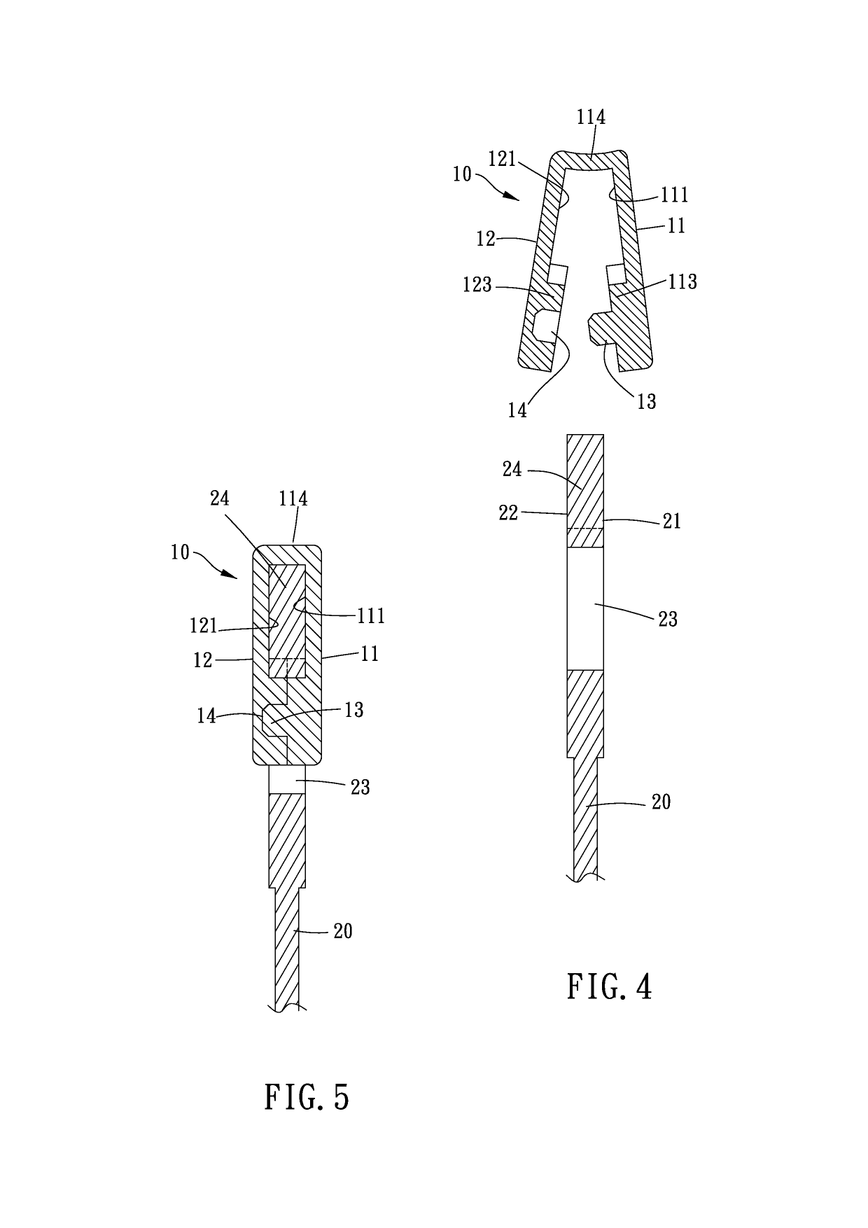

Compared to the aforementioned embodiment, in an alternative embodiment as shown in FIGS. 4 and 5, a connecting mechanism includes the abutting portion 114. The abutting portion 114 is integrally formed between the first and second clamping portions 11, 12 and deformable. As the first and second clamping portions 11, 12 are attached on the first and second surfaces 21, 22 of the hanger 20, the abutting portion 114 slightly deforms and the first and second clamping portions 11, 12 slightly splay outwardly, as shown in FIG. 4. After the abutting portion 114 abuts against and rests on the top of the hanger 20, the abutting portion 114 returns to its original shape and the first and second clamping portions 11, 12 move toward each other. The posts 13 are then disposed through the hanging hole 23 and inserted into the receiving holes 14, so that the detachable member 10 is stably attached to the hanger 20, as shown in FIG. 5.

In another embodiment, the first protrusion 113 may be formed without any post and the second protrusion 123 may be formed without any receiving hole, and the abutting portion 114 is integrally formed between the first and second clamping portions 11, 12 to serves as the connecting mechanism. As such, the detachable member 10 can also be stably attached to the hanger 20, and furthermore, the position in which the detachable member 10 is located can be adjusted.

The detachable member 10 can be used as a tag. Pigment, paster, printed text or pattern, or etched text or pattern may be disposed on the detachable member 10 so that the detachable member 10 is much conspicuous and recognizable. As such, as the detachable member 10 is attached to the hanger 20 (especially, the detachable member 10 is located above the hanging hole 23), purchaser's view of the detachable member 10 will not be obstructed so that the hanger 20 is pretty attractive. Since the detachable member 10 is pretty conspicuous, recognizable and attractive, purchasers can notice articles with the detachable member 10 attached thereto far away from the articles easily.

If an article with the detachable member 10 is exhibited on an incorrect suspender, the misplacement of the article can be easily observed far away from the article, and the article can be then moved to a correct suspender. Thus, the misplacement of articles on suspenders can be avoided and the management of articles is efficient.

Additionally, the detachable member 10 can serve as the encompassing rib 24 between the top portion of the hanger 20 and the top portion of the hanging hole 23, the detachable member 10 can enhance the structure strength of the hanger 20 so that the detachable member 10 and the hanger 20 is uneasy to brake.

Since the detachable member 10 is detachable, the hanger 20 can be manufactured first and the detachable member 10 may be then optionally manufactured accordingly to serve as a tag portion for various requirement or budget concern; the detachable member 10 may be detached from the hanger 20 or replaced by another one, thus providing expandable uses.

Although particular embodiments of the invention have been described in detail for purposes of illustration, various modifications and enhancements may be made without departing from the spirit and scope of the invention. Accordingly, the invention is not to be limited except as by the appended claims.

1. A detachable member for detachably mounting to a hanger the detachable member including a first clamping portion, a second clamping portion and a connecting mechanism, the first and second clamping portions being connected together via the connecting mechanism and being for disposing respectively on a first surface and a second surface of the hanger;
wherein the first and second clamping portions are detachable from each other;
wherein a top of one of the first and second clamping portions extends to form an abutting portion, and the abutting portion is for being abutted against one side of the hanger as the first and second clamping portions are connected together via the connecting mechanism.

2. The detachable member of claim 1, wherein the connecting mechanism includes at least one post and at least one receiving hole, one of the first and second clamping portions is provided with the post and the other with the receiving hole, and the post is for being disposed through a hanging hole of the hanger and inserted into the receiving hole.

3. (canceled)

4. (canceled)

5. The detachable member of claim 1, wherein the first clamping portion includes a first surface and a second surface, the first surface of the first clamping portion is formed with a first protrusion, the second clamping portion includes a first surface and a second surface, the first surface of the first clamping portion is formed with a second protrusion, and the first and second protrusions are for being disposed within a hanging hole of the hanger as the first and second clamping portions are connected together via the connecting mechanism.

6. The detachable member of claim 5, wherein the first surface of the first clamping portion and the first surface of the second clamping portion are for being engaged respectively with the first and second surfaces of the hanger.

7. The detachable member of claim 5, wherein a top portion of the assembled first and second protrusions is constructed for being substantially complementary with a top portion of the hanging hole in shape.

8. A detachable member for detachably mounting to a hanger, the detachable member including a first clamping portion, a second clamping portion and a connecting mechanism, the first and second clamping portions being connected together via the connecting mechanism and being for disposing respectively on a first surface and a second surface of the hanger;
wherein the connecting mechanism includes an abutting portion, the abutting portion is integrally formed with one of the first and second clamping portions and located between the first and second clamping portions, and the abutting portion is for being abutted against one side of the hanger as the first and second clamping portions are to be disposed respectively on the first and second surfaces of the hanger.

9. The detachable member of claim 8, wherein the first clamping portion includes a first surface and a second surface, the first surface of the first clamping portion is formed with a first protrusion, the second clamping portion includes a first surface and a second surface, the first surface of the first clamping portion is formed with a second protrusion, and the first and second protrusions are for being disposed within a hanging hole of the hanger as the first and second clamping portions are connected together via the connecting mechanism.

10. The detachable member of claim 9, wherein the first surface of the first clamping portion and the first surface of the second clamping portion are for being engaged respectively with the first and second surfaces of the hanger.

11. The detachable member of claim 9, wherein a top portion of the assembled first and second protrusions is constructed for being substantially complementary with a top portion of the hanging hole in shape.

12. The detachable member of claim 1, wherein a bottom of the first clamping portion is formed with a first recess, a bottom of the second clamping portion is formed with a second recess, and the first and second recesses correspond to each other in shape and position.
